(19) United States
(12) Patent Application Publication
(10) Pub. No.: US 2026/0186363 A1
(43) Pub. Date: Jul. 2, 2026

(54) ELECTROLYTE FILM CAPABLE OF REVERSIBLE METAL ELECTRODEPOSITION

(71) Applicant: Tynt Technologies, Inc., Boulder, CO (US)

(72) Inventors: Matthew Kent McBride, Boulder, CO (US); Sarah Elizabeth Livingston, Golden, CO (US); Tyler Steven Hernandez, Boulder, CO (US); David Allen Brewster, Commerce City, CO (US); Laura Lynn Schoeneman, Thorton, CO (US); Molly Olivia Teece, Superior, CO (US); Elizabeth Anna Delesky, Westminster, CO (US); Ameen Khalil Saafir, Broomfield, CO (US)

(73) Assignee: Tynt Technologies, Inc., Boulder, CO (US)

(21) Appl. No.: 19/399,403

(22) Filed: Nov. 24, 2025

Related U.S. Application Data
(60) Provisional application No. 63/725,461, filed on Nov. 26, 2024.

(51) Int. Cl. G02F 1/1506; C08J 3/11; C08J 5/18; C08K 3/16; C08K 5/098; C08K 5/19; G02F 1/15; G02F 1/155

(52) U.S. Cl. CPC G02F 1/1506; C08J 3/11; C08J 5/18; C08K 3/16; C08K 5/098; C08K 5/19; G02F 1/155; C08J 2333/12; C08K 2003/168; G02F 2001/164

(57) ABSTRACT

The present disclosure relates to a gel polymer electrolyte (GPE) film capable of reversible metal electrodeposition. The GPE film comprises a polymer mixed with a plasticizer, including solvents and salts, and exhibits specific viscoelastic properties for mechanical stability and effective metal deposition. The disclosure also includes methods for processing the GPE into a film using high shear mixing and extrusion techniques.

### CROSS REFERENCE TO RELATED APPLICATION

This application claims priority to U.S. Provisional Ser. No. 63/725,461, filed Nov. 26, 2024, the content of which is incorporated herein by reference in its entirety.

### FIELD

The present disclosure relates generally to the field of electrochemistry, and more specifically to the formulation and manufacture of electrochemical films.

### BACKGROUND

Reversible metal electrodeposition (RME) is a critical process in various electrochemical devices, including batteries, electrochromic devices, and reversible mirrors. Traditional methods may utilize gel electrolytes formed from various polymers and solvents. However, these methods often lack the necessary mechanical properties and stability for durable and efficient RME. Existing patents and literature describe the use of gelling agents and polymers but do not adequately address the specific viscoelastic properties required for effective RME, nor do they provide detailed processing methods for forming these materials into films.

Accordingly, there exists a need for improved compositions and methods for producing electrochemical films having desirable mechanical and viscoelastic properties for durable and efficient RME.

### BRIEF SUMMARY

The present disclosure provides a free-standing gel polymer electrolyte (GPE) film with a thickness ranging from, for example, 100 to 2000 microns. This film can be laminated between two electrodes to facilitate reversible metal electrodeposition. The GPE film comprises a polymer mixed with a plasticizer, which includes solvents and salts that enable RME. The film exhibits specific viscoelastic properties that ensure mechanical stability and effective metal deposition. The disclosure also includes methods for processing the GPE into a film using high shear mixing and extrusion techniques.

### BRIEF DESCRIPTION OF THE DRAWINGS

FIG. 1 shows exemplary viscoelastic and mechanical properties of the GPE film at 1 Hz on a parallel plate rheometer.

FIG. 2 shows a flow diagram illustrating an exemplary process of the compounding and extrusion of the electrolyte plasticizer and polymer into a film.

FIG. 3 shows a diagram depicting an exemplary process of laminating the GPE film between working and counter electrodes with seal materials.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

### I. Definitions

For convenience, certain terms employed in the specification, examples and claims are collected here. Unless defined otherwise, all technical and scientific terms used in this disclosure have the same meanings as commonly understood by one of ordinary skill in the art to which this disclosure belongs.

The singular forms “a,” “an,” and “the” include plural referents unless the context clearly dictates otherwise. Thus, for example, reference to a “polymer” includes a single polymer as well as two or more of the same or different polymers, reference to an “excipient” includes a single excipient as well as two or more of the same or different excipients, and the like.

The term “about”, particularly in reference to a given quantity, is meant to encompass deviations of plus or minus ten percent.

The compositions of the present disclosure can comprise, consist essentially of, or consist of, the components disclosed.

By reserving the right to proviso out or exclude any individual members of any such group, including any sub-ranges or combinations of sub-ranges within the group, that can be claimed according to a range or in any similar manner, less than the full measure of this disclosure can be claimed for any reason.

Throughout this disclosure, various patents, patent applications and publications are referenced. The disclosures of these patents, patent applications and publications in their entireties are incorporated into this disclosure by reference in order to more fully describe the state of the art as known to those skilled therein as of the date of this disclosure. This disclosure will govern in the instance that there is any inconsistency between the patents, patent applications and publications cited and this disclosure.

### II. Gpe Film

Accordingly, the present disclosure describes a GPE film comprising a plasticized linear, branched, or crosslinked polymer, which is processed at elevated temperature and possesses appropriate viscoelastic properties to provide mechanical stability and adhesive properties to the electrolyte. Such a film has the advantages of preventing leaking of low viscosity electrolytes and supporting electrodeposition of a conformal metal film. The electrolyte plasticizer (or simply “plasticizer”) may comprise compatible solvents, active metal salts, supporting salts, UV/oxidative stabilizers, surfactants, combinations thereof, or any other suitable materials. The polymer and plasticizer are combined by mechanical or high shear mixing such as mechanical stirring, tumble mixing, or extrusion (e.g., extrusion through a die with trimming as needed). Once combined, nip rolling, calendaring, or pressing form the mixture into a film with the appropriate dimensions for lamination between two electrodes.

### III. Polymers

The polymer provides mechanical support and preferably forms a gel in the device's working temperature range. Polymer entanglements and physical interactions drive gel formation and dissipate when heated, enabling processing and lamination. As such, the rheological properties are controlled by the chemical composition, plasticizer composition, polymer concentration, and polymer molecular weight. For example, high molecular weight PMMA (>300 kDa) in the GPE facilitates solid-like properties at relatively lower polymer content and facilitates gel properties at higher temperatures. Whereas low molecular weight PMMA (<100 kDa) does not contribute as drastically to increasing viscosity; however, low molecular weight species improve flow at temperature, which is important for processing. Tuning the components of the film enables engineering the proper viscoelastic properties over the whole processing and operating temperature range. In addition, the polymer component may have a latent cross-linkable unit that activates during extended heating thereby forming a chemically crosslinked gel after processing has completed. In some instances, the polymer is thermoplastic polyurethane (TPU).

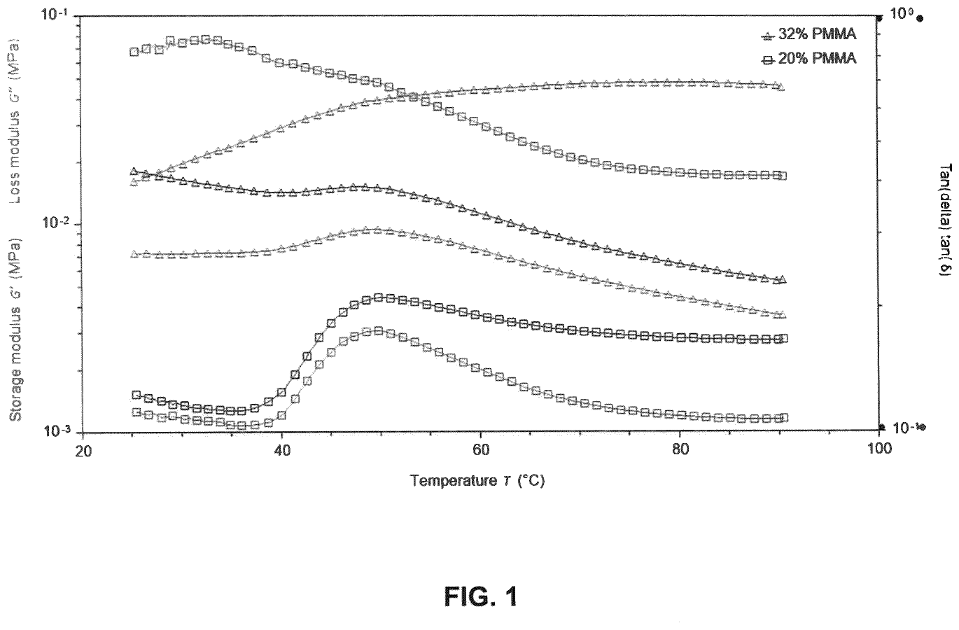

Central to this disclosure is the mechanical and rheological properties of the film and the compositions to reach those properties. The polymer is added in sufficient concentrations, relative to plasticizer, where the viscosity may be high (>1,000 cP) or exceedingly high (>10,000 cP) even in the higher operating temperature range. Preferably, the storage modulus is larger than the loss modulus measured on a parallel plate rheometer until at least 85° C. at 1 Hz or over the whole working temperature range of the RME device. By way of example, FIG. 1 shows exemplary mechanical and rheological properties of the GPE film at 1 Hz on a parallel plate rheometer. The storage modulus should be high enough that the GPE behaves as a solid, but not too high as to inhibit electrochemistry and adhesion. Ideally, this range is 1 kPa to 10 MPa measured at room temperature and 1 Hz. Processing requires the polymer to behave more liquid-like at temperatures outside the operating range of the device (>100° C.). To this end, the flow properties of the GPE are augmented by addition of lower molecular weight PMMA (1 kDa to 300 kDa). For lower temperatures, the electrochemistry is impeded near the glass transition. For instance, in a generic polar organic solvent compatible with PMMA, the glass transition is suppressed up to 40% PMMA, as such, the upper limit for PMMA content is around this value. Ideally, the polymer content is 5-60% based on these criteria. Of note, other polymers and plasticizers may have different compositional ranges, which are also contemplated and included in this disclosure.

Suitable polymers may include poly(methyl methacrylate) (PMMA); PMMA copolymers with methacrylic acid, alkyl (meth)acrylates, and hydroxyl containing (meth)acrylates; poly(acrylonitrile); poly((meth)acrylic acid); poly(vinyl alcohol); poly(vinyl acetate); poly(vinyl butyrate) and copolymers thereof; polyethylene oxide (PEO) and copolymers thereof, and other polymers soluble in polar organic solvents or solvent mixtures. Commercial sources of PMMA include Elvacite 2041, Elvacite 2051, Elvacite 2021C, Elvacite 4026, and Elvacite 4059 from Mitsubishi Chemical.

### IV. Solvents

The solvent for the electrolyte plasticizer plays a critical role in augmenting the viscoelastic properties of the GPE. Polar, aprotic organic solvents are compatible with a wide range of salts and polymers. Ideally, the solvent has a melting and boiling point outside the expected exposed temperature range of the GPE and has minimal electrochemical activity without the active metal salts. Solvents may include sulfolane and sulfolane derivatives, nitriles and derivatives (acetonitrile, 3-methyoxypropionitrile, 3-hydroxypropionitrile, etc.), lactones and derivatives (gamma-valerolactone, gamma-butyrolactone, etc.) dimethylsulfoxide, dimethylformamide (DMF), Dimethylacetamide (DMA), N-methylpyrrolidone (NMP), triethylphosphate and derivatives, cyclic/linear carbonates and derivatives (propylene carbonate, ethylene carbonate, etc), alcohols, water, low molecular weight oligomeric ethylene glycols (hydroxy-, methoxy-, benzoate-, and ethoxy-terminated) and mixtures thereof. In some instances, the solvent belongs to the class of glymes, also known as glycol diethers.

### V. Salts

The appropriate combination of salts is required to facilitate RME. The salts are broken down to active metal salt analytes and supporting electrolytes. Active metal salts contain the cationic species that are being plated and stripped within the applied voltage window that include monovalent, divalent, and/or trivalent metals including, but not limited to, Zn2⁺, Bi³⁺, Ag¹⁺, Ni²⁺, Sn²⁺, Cu²⁺, Mn²⁺, Al³⁺, In³⁺, Ga³⁺, Co²⁺, Fe^{2+,3+}, and mixtures thereof. Additionally, these salts could be added to systems that do not operate near the reduction potential and would behave as background electrolyte salts. The important characteristics of these metal cations are oxophilicity, standard reduction potential relative to the choice of anions, solvents, and polymers, cost, and theoretical coloration efficiency. These salts are accompanied by a variety of anions listed below including, but not limited to: Cl⁻, Br⁻, I⁻, ClO₄, NO₃, SO₄²⁻, CH₃SO₃⁻, CF₃SO₃⁻, BF₄⁻, PF₆⁻, (CF₃SO₂)₂N⁻, acetate, trifluoroacetate, propionate, butyrate, and mixtures thereof. The important characteristics of these metal anions are solubility, stable voltage windows relative to the choice of cations, solvents, and polymers, cost, and coordination to the metal cations for ionic conductivity and diffusivity. Supporting electrolytes are electrochemically inactive; however, background salts facilitate improved reversibility, conductivity, and plating morphology. The cations in this category include alkali metal salts (Na¹⁺, Li¹⁺, K¹⁺), derivatives of ammonium (tetramethylammonium, tetrabutyl ammonium, etc.), Mg²⁺, Cs¹⁺. The listed cations can be paired with anions including, but not limited to: Cl⁻, Br⁻, I⁻, ClO₄⁻, NO₃⁻, SO₄²⁻, CH₃SO₃⁻, CF₃SO₃⁻, BF₄⁻, PF₆⁻, (CF₃SO₂)₂N³¹ , acetate, trifluoroacetate, propionate, butyrate, and mixtures thereof. Ionic liquids may also be used to increase conductivity of gel polymer electrolyte and act as supporting electrolytes. Examples of ionic liquids include, but are not limited to, ammonium ionic liquids, imidazolium ionic liquids, phosphonium ionic liquids, piperidinium ionic liquids, pyrrolidinium ionic liquids, etc.

### VI. Other Components

Other components may be used in manufacturing the film, including surfactants, acids, ligands, and excipients, which are also contemplated and included in this disclosure.

### VII. Processing

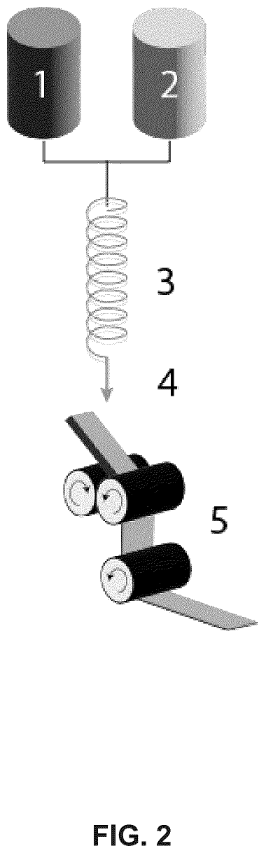

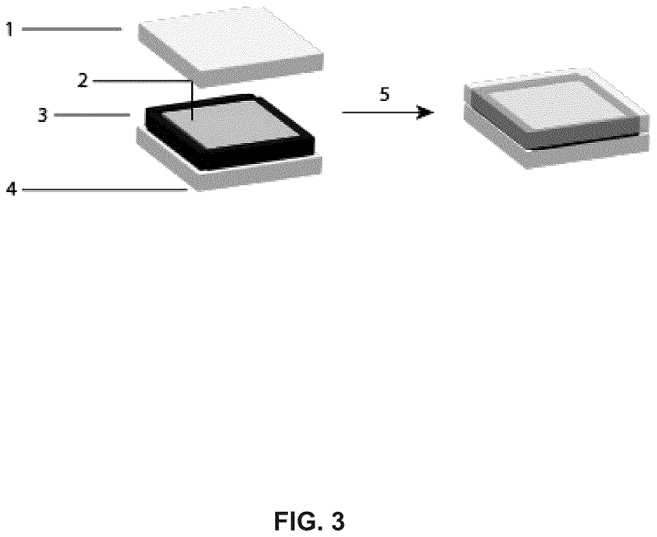

The mechanical properties of the film dictate the processing equipment and conditions required to scale up to larger area devices. To mix, high shear mixing, heating, and/or compounding are required to form a uniformly mixed GPE. From here, the GPE could be extruded through a die with a width up to 10 feet and thickness ranging from 0.1 mm to 10 mm. Further processing could include calendaring, nip rolling, and lamination of electrode or release liner to produce a film or film stack for lamination into electrochemical devices. Examples of release liners are VIR teflon PTFE (ptfe), diamond release (silicone), tivar HOT plate white (UHMW-PE), high-temperature moisture-resistant polyester (polyester), high-temperature FEP (fep), PEEK. On smaller scales, processing is done by addition of polymer to a stirring electrolyte solution until the viscosity is too high for magnetic stirring. The GPE is moved to a heated tumble mixer until the homogenized (2-24 hours). FIG. 2 shows an exemplary process flow diagram illustrating the compounding and extrusion of the electrolyte plasticizer and polymer into a film, in which the electrolyte plasticizer (1) and polymer (2) are compounded (3) and extruded through a die (4), and optionally trimmed and calendared (5) into a film with the appropriate dimensions for lamination into a device or rolled up for storage. FIG. 3 shows an exemplary diagram depicting the lamination of the GPE film between working and counter electrodes with seal materials, in which the film (2) is laminated between a working (1) and counter electrodes (4) with seal materials (3) placed along the perimeter. Heated vacuum lamination (5) seals the device.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### EXAMPLES

The following examples are offered to illustrate provided embodiments and are not intended to limit the scope of the present disclosure.

Example 1: Zinc Bromide (100 mM, 10.134 g) and sodium acetate (100 mM, 3.690 g) are dissolved in 99.9 mL of DMSO and 233.1 mL of propylene carbonate. With heat and mechanical stirring, 117.0 g of PMMA (350 kDa, Sigma Aldrich) are added to the mixture. Once the viscosity of the mixture rises sufficiently to prevent mechanical stirring on a magnetic stirring hot plate, the mixture is transferred to a heated roller and tumble mixed until the PMMA is uniformly dissolved. The GPE is further processed into a sheet.

Example 2: To make the electrolyte plasticizer, Zinc Bromide (100 mM, 10.134 g) and sodium acetate (100 mM, 3.690 g) are dissolved in 99.9 mL of DMSO and 233.1 mL of propylene carbonate. The electrolyte plasticizer and 117.0 g of PMMA (350 kDa, Sigma Aldrich) are compounded with heat and extruded into a 3.5 inch wide and 1 mm thick film that is rolled onto a release liner. The film/liner stack is trimmed to a 3.5 inch by 3.5-inch square and placed on a counter electrode surrounded by PIB as a barrier parameter. A working electrode is placed on top of the assembly and the assembly is laminated to form an electrochemical device.

Example 3: Zinc Bromide (500 mM, 15.7 g) and Sodium Butyrate (500 mM, 7.68 g) are dissolved in 125 mL of sulfolane. PEO (MW: 200 kDa, 17.5 grams) is added to a stirring salt solution and heated to 100° C. Once the viscosity of the mixture rises sufficiently to prevent mechanical stirring on a magnetic stirring hot plate, the mixture is transferred to a heated roller and tumble mixed until the PEO is uniformly dissolved. The GPE is further processed into a sheet for use in electrochemical cells. In addition, PEO of varied molecular weight (200 kDa, 1,000 kDa) could be added to further augment the viscoelastic properties.

Example 4: Bismuth Bromide (100 mM, 6.73 g) and tetrabutylammonium PF6 (200 mM, 11.62 g) are dissolved in 150 mL of TEP. PMMA (350 kDa, 15 g) is added to the stirring salt solution and heated to 100° C. Once the viscosity of the mixture rises sufficiently to prevent mechanical stirring on a magnetic stirring hot plate, the mixture is transferred to a heated roller and tumble mixed until the PMMA is uniformly dissolved. The GPE is further processed into a sheet for use in electrochemical cells.

Example 5: Bismuthyl perchlorate monohydrate (500 mM, 0.34 g) is dissolved in 2 mL of 50:50 v:v gamma-butyrolactone: 3-methoxypropionitrile. PMMA (350 kDa, 0.3g) is added to the stirring salt solution and heated to 80° C. After one hour of mixing, a clear, homogenous, viscous solution is obtained. A doctor blade coating system can be used to create a 1 mm thick electrolyte film on release liner. Once cooled to room temperature, the resulting film is a free-standing GPE sheet that can be trimmed for use in electrochemical cells.

Taken together, these examples demonstrate successful implementation of using the disclosed compositions and methods to manufacture the GPE films of the invention, which are useful for a variety of applications such as reversible mirrors, thermal camouflage, infrared modulation, interior partitions, and privacy glass.

1. A gel polymer electrolyte film, comprising:
a polymer; and
an electrolyte plasticizer, comprising at least one solvent, at least one active metal salt, and at least one supporting salt,
wherein the film facilitates reversible metal electrodeposition between two electrodes.

2. The film of claim 1, wherein the polymer is selected from the group consisting of poly(methyl methacrylate) (PMMA), poly(acrylonitrile), poly(vinyl alcohol), poly(vinyl acetate), thermoplastic polyurethanes (TPU), polyethylene oxide (PEO), and derivatives thereof.

3. The film of claim 1, wherein the plasticizer comprises dimethyl sulfoxide (DMSO) and/or propylene carbonate.

4. The film of claim 1, wherein the polymer content is between about 5% and about 60% by weight.

5. The film of claim 1, wherein the storage modulus is greater than the loss modulus measured on a parallel plate rheometer until at least 85° C. at 1 Hz.

6. The film of claim 1, wherein the at least one solvent is selected from the group consisting of sulfolane, lactone, nitrile, carbonate, glyme, triethylphosphate, carbonate, ethylene glycol, alcohol, dimethylsulfoxide (DMSO), dimethylformamide (DMF), Dimethylacetamide (DMA), water, N-methylpyrrolidone (NMP), and derivatives thereof.

7. The film of claim 1, wherein at least one active metal salt is selected from the group consisting of Zn2+, Bi3+, Ag1+, Ni2+, Sn2+, Cu2+, Mn2+, Al3+, In3+, Ga3+, Co2+, and Fe2+/3+.

8. The film of claim 1, wherein the at least one supporting salt is selected from the group consisting of an alkali metal salt, a derivative of ammonium, a magnesium salt, and a cesium salt.

9. The film of claim 1, wherein the at least one active metal salt and/or the at least one supporting salt are accompanied by anions selected from the group consisting of Cl⁻, Br⁻, I⁻, ClO₄⁻, NO₃⁻, SO₄²⁻, CH₃SO₃⁻, CF₃SO₃⁻, BF₄⁻, PF₆⁻, (CF₃SO₂)₂N⁻, acetate, trifluoroacetate, propionate, and butyrate.

10. The film of claim 1, wherein the polymer comprises a latent cross-linkable unit that activates during extended heating to form a chemically crosslinked gel.

11. The film of claim 1, further comprising one or more UV/oxidative stabilizers, one or more surfactants, one or more acids, and/or one or more ligands.

12. The film of claim 1, wherein the film is processed into a sheet using nip rolling, extruding through a die, calendaring, and/or pressing.

13. Use of the film of claim 1, wherein the use is for producing reversible mirrors, thermal camouflage, infrared modulation, interior partitions, and/or privacy glass.

14. An electrochromic glass, comprising:
a gel polymer electrolyte film laminated between two electrodes,
wherein the film facilitates reversible metal electrodeposition.

15. The electrochromic glass of claim 14, wherein the electrodes are selected from the group consisting of zinc, bismuth, silver, nickel, tin, copper, manganese, aluminum, indium, gallium, cobalt, and iron.

16. The electrochromic glass of claim 14, wherein the film has a thickness ranging from about 100 to about 2000 microns.

17. A method for producing a gel polymer electrolyte film, comprising:
mixing a polymer with an electrolyte plasticizer under high shear conditions; and
processing the mixture into a film.

18. The method of claim 17, wherein the high shear conditions comprise compounding and/or extrusion.

19. The method of claim 17, further comprising a step of laminating the film between two electrodes.

20. The method of claim 17, wherein the polymer and the electrolyte plasticizer are mixed by mechanical stirring, tumble mixing, or extrusion.
